(19) United States
(12) Patent Application Publication
(10) Pub. No.: US 2026/0088300 A1
(43) Pub. Date: Mar. 26, 2026

(54) Lithium Metal Protection Using Reactive Gas Combinations

(71) Applicant: APPLE INC., Cupertino, CA (US)

(72) Inventors: Shawn W. Snyder, Santa Cruz, CA (US); Elahe Moazzen, Palo Alto, CA (US); Mark J. Eggenberger, San Jose, CA (US); Martin Bettge, Mountain View, CA (US)

(21) Appl. No.: 19/294,391

(22) Filed: Aug. 8, 2025

Related U.S. Application Data
(60) Provisional application No. 63/696,996, filed on Sep. 20, 2024.

(51) Int. Cl. H01M 4/62; C23C 8/06; C23C 8/34; H01M 4/04

(52) U.S. Cl. CPC H01M 4/628; C23C 8/06; C23C 8/34; H01M 4/0402

(57) ABSTRACT

A passivation process for a lithium metal anode includes subjecting lithium metal to a passivation gas having the following composition: two or more gases selected from the group consisting of CO₂, O₂, H₂O, N₂, HC, CO, H, He, F, and SiH₄; and optionally, a noble gas. The passivation gas reacts with the lithium metal to form a passivation layer on the lithium metal that is less than ten microns in depth.

### CROSS-REFERENCE TO RELATED APPLICATIONS

This application claims the benefit of U.S. Provisional Application No. 63/696,996, filed on Sep. 20, 2024, the content of which is hereby incorporated by reference in its entirety herein for all purposes.

### TECHNICAL FIELD

This disclosure relates to combinations of reactive gases that create a passivation layer on lithium metal, protecting the lithium metal from further environmental degradation.

### BACKGROUND

Lithium metal batteries plate lithium onto the anode with every use cycle. This fresh lithium plating is highly pure and susceptible to reaction with most gases. This corrosion reaction is irreversible, reducing the amount of lithium metal available for plating and thus reducing the life of the battery. Generally, a battery life has reached its end when the lithium metal anode has lost about 20% of its surface area.

Conventionally, argon gas may be used in the battery cell to protect lithium metal from reacting with oxygen, nitrogen, water, and other gases in the air. Argon is meant to prevent lithium from oxidizing, becoming hydrated, or forming nitrides. However, some contamination of the argon or surface contamination in the cell, no matter how slight, is unavoidable in real-world manufacturing. Lithium metal is exposed to this environment in its container, the edges of the lithium metal being particularly vulnerable to exposure. This exposure leads to degradation of the battery life.

### SUMMARY

Disclosed herein are implementations of a passivation gas for lithium metal in a gas environment, such as a lithium metal anode in electrochemical cells. The passivation gas has a finite reaction with the lithium metal, producing a passivation layer that is dense, has minimal depth, and impedes further reaction with the lithium metal. The passivation layer resulting from the passivation gas reaction with lithium metal limits the lithium metal loss and extends the cycle life.

An implementation of a passivation gas for lithium metal has the following composition: two or more gases selected from the group consisting of CO₂, O₂, H₂O, N₂, HC, CO, H, He, F, and SiH₄.

Another implementation of a passivation gas for lithium metal has the following composition: two or more gases selected from the group consisting of CO₂, O₂, H₂O, N₂, HC, CO, H, He, F, and SiH₄; and an inert gas.

Also disclosed are implementations of a process to passivate lithium metal.

In one implementation, a passivation process for a lithium metal includes subjecting lithium metal to a passivation gas having the following composition: two or more gases selected from the group consisting of CO₂, O₂, H₂O, N₂, HC, CO, H, He, F, and SiH₄; and optionally, a noble gas. The passivation gas reacts with the lithium metal to form a passivation layer on the lithium metal that is less than ten microns in depth.

In another implementation, a passivation process for a lithium metal battery cell comprises subjecting lithium metal to a first passivation gas during cell formation having the following composition: two or more gases selected from the group consisting of CO₂, O₂, H₂O, N₂, HC, CO, H, He, F, and SiH₄; and optionally, a noble gas. Then, subjecting lithium metal to a second passivation gas during packaging for use having the following composition: two or more gases selected from the group consisting of CO₂, O₂, H₂O, N₂, HC, CO, H, He, F, and SiH₄; and optionally, a noble gas. The first and second passivation gases may be the same or different.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of an electrochemical cell as disclosed herein.

FIG. 2 is a flow diagram of a passivation process as disclosed herein.

### DETAILED DESCRIPTION

Lithium metal batteries have a higher energy density than conventional lithium-ion batteries. However, the integration of lithium metal into electrochemical cells presents its own challenges. The lithium metal that plates on the anode with every cycle is highly pure and susceptible to reaction with most any gas present in the electrochemical cell container environment. This corrosion reaction is irreversible, reducing the life of the battery. Therefore, keeping the environment within the cell free from reactive gases and contaminants is important to achieve the desired battery life. However, it is not practical in real-world manufacturing to obtain a reactive gas-free and/or contaminant free environment. As examples, amounts as low as <0.1 ppm of H₂O or O₂ can cause lithium metal corrosion. Traces of H₂O can have a large impact on CO₂, O₂ and N₂ reactivities, and can be a prominent reason for lithium corrosion in the cell.

Attempts have been made to create a non-reactive environment for the electrochemical cell using argon. Results show it is not realistic to manufacture the anodes or the electrochemical cells having a pure argon environment or a perfectly clean environment.

Disclosed herein is a passivation gas for lithium metal used as an anode in electrochemical cells. The passivation gas has a finite reaction with the lithium metal, producing a passivation layer that is dense, has minimal depth, and impedes further reaction between the lithium metal and other reactants. The passivation layer resulting from the passivation gas reaction with lithium metal limits the lithium metal loss and extends the cycle life.

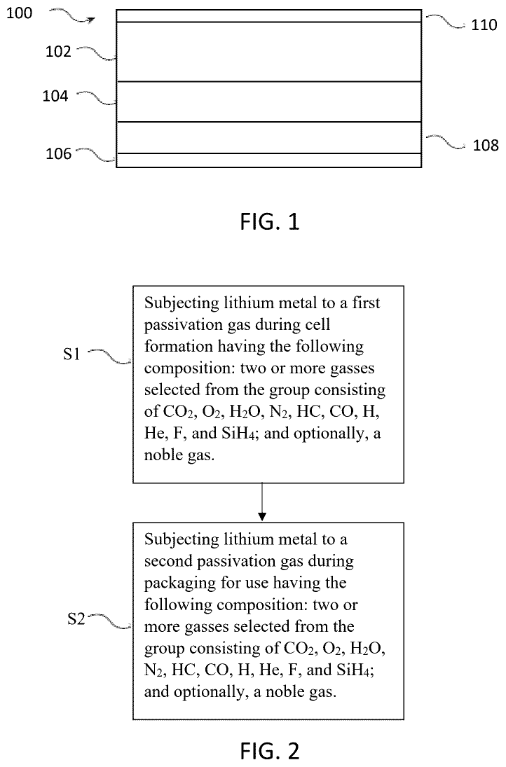

The passivation gas can be applied to any lithium metal in a gas environment. Any surface of the lithium metal exposed to the passivation gas will be passivated and converted into a different lithium compound depending on the passivation gas used. The passivation gas can also be applied during electrochemical cell formation, during packaging of the cell for use, and during manufacture of the lithium metal anode when it is to be assembled into the cell in a different location in which the lithium metal anode is made. The electrochemical cell can be an all-solid-state battery (ASSB) cell, such as that illustrated in FIG. 1. The electrochemical cell 100 of FIG. 1 may be configured as a layered ASSB cell that has active layers including a cathode 102 having active cathode material, an electrolyte 104 that is solid electrolyte material, an anode current collector 106, and a lithium metal anode 108 passivated as disclosed herein. In addition, the electrochemical cell 100 of FIG. 1 may include a cathode current collector 110, configured such that the active layers are interposed between the anode current collector 106 and the cathode current collector 110. Alternatively, the electrochemical cell 100 may use a liquid or gel electrolyte as electrolyte 104 and may further include a separator in the liquid or gel electrolyte between the lithium metal anode 108 and the cathode 102. A battery is formed of multiple electrochemical cells 100.

An implementation of a passivation gas for a lithium metal anode has the following composition: two or more gases selected from the group consisting of CO₂, O₂, H₂O, N₂, HC, CO, H, He, F, and SiH₄. The passivation gas may consist of the two or more gases selected from the group consisting of CO₂, O₂, H₂O, N₂, HC, CO, H, He, F, and SiH₄. Both the concentrations and the ratios of the two or more gases are optimized to produce a finite reaction with lithium metal, forming a passivation layer on the lithium metal that is ten microns or less in thickness. This passivation layer blocks further ingress of gases and blocks lithium diffusion from the inside.

Another implementation of a passivation gas for a lithium metal anode has the following composition: two or more gases selected from the group consisting of CO₂, O₂, H₂O, N₂, HC, CO, H, He, F, and SiH₄; and an inert gas. The passivation gas may consist of the two or more gases selected from the group consisting of CO₂, O₂, H₂O, N₂, HC, CO, H, He, F, and SiH₄; and one or more inert gas. Both the concentrations and the ratios of the two or more gases are optimized to produce a finite reaction with lithium metal, forming a passivation layer on the lithium metal that is ten microns or less in thickness. This passivation layer blocks further ingress of gases and blocks lithium diffusion from the inside.

When an inert gas is used as a carrier gas for the two or more reactant gases, the two or more reactant gases may be less than or equal to 5.0 wt. % of the total passivation gas.

The combination of two or more of the gases is important. It has been found that certain amounts of single reactant gas will produce dendrites. For example, 20 wt. % O₂ in argon produced dendritic plating. As another example, pure CO₂ as low as 1.0 wt % in argon also produces dendritic plating.

Also disclosed are implementations of a process to passivate lithium metal.

In one implementation, a passivation process for a lithium metal anode includes subjecting lithium metal to a passivation gas having the following composition: two or more gases selected from the group consisting of CO₂, O₂, H₂O, N₂, HC, CO, H, He, F, and SiH₄; and optionally, a noble gas. The passivation gas has a finite reaction with the lithium metal to form a passivation layer on the lithium metal that is less than ten microns in depth.

In another implementation, shown in FIG. 2, a passivation process for a lithium metal battery cell comprises step S1, subjecting lithium metal to a first passivation gas during cell formation having the following composition: two or more gases selected from the group consisting of CO₂, O₂, H₂O, N₂, HC, CO, H, He, F, and SiH₄; and optionally, a noble gas.

Exposed surfaces of the lithium metal will be passivated, including the surfaces perpendicular to the anode current collector (i.e., vertical side walls perpendicular to the plane of the cell) and any lithium metal surface not covered by any other means such as the anode current collector, which allows the lithium metal to be exposed to the environment. The first passivation gas used as cell formation occurs is formulated to have a ratio and concentration that provides optimum results during the first few cycles, the cell formation.

Subsequently, in step S2, lithium metal is subjected to a second passivation gas during packaging for use having the following composition: two or more gases selected from the group consisting of CO₂, O₂, H₂O, N₂, HC, CO, H, He, F, and SiH₄; and optionally, a noble gas. Exposed surfaces of the lithium metal will be passivated, including the surfaces perpendicular to the anode current collector (i.e., vertical side walls perpendicular to the plane of the cell) and any lithium metal surface not covered by any other means such as the anode current collector, which allows the lithium metal to be exposed to the environment. This second passivation in step S2 can create a layered structure in which the second layer is on top of the first passivation layer or can create a situation in which the first layer composition and/or properties are modified by the second passivation. The second passivation gas has a ratio and concentration that is optimized for the point of application. The first and second passivation gases may be the same or different.

The passivation gas produces a passivation layer having a Pilling-Bedworth Ratio (PBR) of between 1 and 2, inclusive. The PBR represents the degree of volume change that lithium experiences when it is reacting with a gas or mixture of gases.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A passivation gas for lithium metal, the passivation gas consisting of:
two or more gases selected from the group consisting of CO₂, O₂, H₂O, N₂, HC, CO, H, He, F, and SiH₄.

2. A passivation gas for lithium metal, the passivation gas consisting of:
two or more gases selected from the group consisting of CO₂, O₂, H₂O, N₂, HC, CO, H, He, F, and SiH₄; and
a noble gas.

3. The passivation gas of claim 2, wherein the noble gas is argon.

4. A passivation process for lithium metal, the passivation process comprising:
subjecting lithium metal to a first passivation gas having a following composition:
two or more gases selected from the group consisting of CO₂, O₂, H₂O, N₂, HC, CO, H, He, F, and SiH₄; and
optionally, a noble gas,
wherein the first passivation gas reacts with exposed surfaces of the lithium metal to form a passivation layer on the exposed surfaces that is less than ten microns in depth.

5. The passivation process of claim 4, wherein the passivation layer has a Pilling-Bedworth Ratio of between 1 and 2, inclusive.

6. The passivation process of claim 4, wherein the lithium metal is an anode in an electrochemical cell.

7. The passivation process of claim 6, wherein the electrochemical cell is an all-solid-state battery cell.

8. The passivation process of claim 6, wherein the electrochemical cell is a lithium metal battery cell, wherein the subjecting the lithium metal occurs during cell formation, the passivation process further comprising:
subsequently subjecting the exposed surfaces of the lithium metal to a second passivation gas during packaging for use, the second passivation gas having the following composition:
two or more gases selected from the group consisting of CO₂, O₂, H₂O, N₂, HC, CO, H, He, F, and SiH₄; and
optionally, a noble gas.

9. The passivation process of claim 8, wherein the first passivation gas and the second passivation gas have equal compositions.

10. The passivation process of claim 8, wherein the first passivation gas and the second passivation gas have different compositions.

11. The passivation process of claim 8, wherein subjecting the exposed surfaces of the lithium metal to the second passivation gas produces a second passivation layer that is less than ten microns in thickness.

12. The passivation process of claim 8, wherein subjecting the exposed surfaces of the lithium metal to the second passivation gas modifies a composition of the first passivation layer.

13. The passivation process of claim 8, wherein subjecting the exposed surfaces of the lithium metal to the second passivation gas modifies one or more properties of the first passivation layer.
